(19) United States
(12) Patent Application Publication
(10) Pub. No.: US 2006/0259353 A1
(43) Pub. Date: Nov. 16, 2006

(54) Shared vehicle transportation systems and methods for individuals and entities

(76) Inventor: Steven Patrick Gutmann, Portland, OR (US)

Correspondence Address: PRESTON GATES ELLIS & ROUVELAS MEEDS LLP, 1735 NEW YORK AVENUE, NW, SUITE 500, WASHINGTON, DC, 20006, US

(21) Appl. No.: 11/140,254

(22) Filed: May 31, 2005

(51) Int. Cl. G07B 15/00; G06Q 10/00

(52) U.S. Cl. 705/13; 705/5

(57) ABSTRACT

Disclosed herein are vehicle-sharing systems and methods that reduce the need for private vehicle ownership by individuals and/or entities. The systems and methods utilize a pool of vehicles available for hire; at least one collection point at which the vehicles are issued; a central reservation system; and a system to verify user identify and reservation status wherein the system receives identifying information from a potential user, communicates the identifying information to the central reservation system which prompts the system to allow access to a reserved vehicle from the pool of vehicles available for hire in response to positive verification of the user and reservation status. In the vehicle-sharing systems and methods of the present invention, a subset of vehicles in the pool are designated to be hired by entities rather than individuals during specified time periods.

### FIELD OF THE INVENTION

The invention relates to vehicle-sharing systems and methods that reduce the need for private vehicle ownership by individuals and/or entities.

### BACKGROUND OF THE INVENTION

Transportation is an important part of everyday life. Movement of people and goods is essential in urban areas which have largely relied on private vehicles for accomplishing this task. Growth in urban areas, however, has made such reliance increasingly ineffective and extremely expensive in money, space, energy and ecological consequences.

Increasing congestion on roads and the problems associated therewith generally has caused governments to give more attention to mass transit. Mass transit, however, is often too inflexible, unreliable and slow to meet the needs of many potential users. Thus, some users are looking at short-term vehicle rentals as an alternative to provide for their everyday mobility needs.

Communities and governments have generally been very supportive of such emerging modes of vehicle rental—often called car sharing—because they can significantly reduce the impact of private vehicles on traffic congestion, the environment and transport infrastructures. Ultimately, widely available low-emission rental vehicles can encourage the combined use of public and private transportation, improve air quality, reduce parking space requirements and influence urbanization. As more and more riders subscribe to the services, more cars will be taken off the road and less gridlock will occur. Individual subscribers also save time and cost when freed of car ownership, maintenance and insurance costs.

While such car-sharing programs have been successful in encouraging some individuals to relinquish private car ownership in favor of shared use cars, there is still room for improvement in these systems. For example, as presently used, such programs generally target individual commuters. One individual commuter/subscriber to a car sharing program who rides public transit and uses a shared vehicle during the workday only reduces the use of one private vehicle. One area for improvement therefore includes targeting subscribers whose use may reduce the use of more than one private vehicle. Further, as presently used, many such programs do not actively promote car pooling use of the shared vehicles. Thus, another area for improvement includes promoting the use of such shared cars for car pooling purposes. The present invention addresses these areas that can still be improved through the use of car-sharing programs.

### SUMMARY OF THE INVENTION

The present invention is directed to systems and methods that can reduce dependency on private car ownership by both individuals and entities. The present invention combines the convenience of car sharing with traditional car pools or van pools. Specifically, the systems and methods of the present invention allow an entity to reserve a shared vehicle during certain specified times. In some instances, the entity may be, for example, a corporate entity or an employer. This entity can allow a group of commuters (in one example, employees) to share the reserved vehicle for part or all of their daily commute to a common destination. After arrival at the common destination, the same vehicle can be available for use by the entity in any way it sees fit. For example, if an employer, the entity can allow employees to use the hired vehicle during the hired period for errands, meetings, etc. The entity could also use the hired vehicle during the hired period as a company fleet vehicle, if applicable. During times outside of those designated for use by entities, the same vehicle can be reserved by individual subscribers of the car sharing program. Thus, the systems and methods of the present invention allow a same vehicle to be used by several different groups of people at different times without conflict.

In one embodiment of the systems of the present invention the system comprises a pool of vehicles available for hire; at least one collection point at which the vehicles are issued; a central reservation system; and a system to verify user identify and reservation status, wherein the system receives identifying information from a potential user, communicates the identifying information to the central reservation system which prompts the system to allow access to a reserved vehicle from the pool of vehicles available for hire in response to positive verification of the user and reservation status wherein a subset of the vehicles in the pool are designated to be hired by entities rather than individuals during specified time periods.

In another embodiment of the systems of the present invention, the collection point is a collection and return point from which the hired vehicles are issued and returned.

In another embodiment of the systems of the present invention, the entity is an employer and the employer authorizes one or more groups of employees to obtain one or more vehicles from the subset of vehicles in the pool from one or more collection points and to use the hired vehicles to car pool to the place of employment.

In another embodiment of the systems of the present invention, the employer uses the hired vehicles as members of the employer's fleet of vehicles after the authorized group of employees arrives at the place of employment in the car pool and before the authorized group of employees leaves the place of employment in the car pool.

In another embodiment of the systems of the present invention, when the employees leave the place of employment in the car pool, the employees return to the collection point which is a collection and return point.

In another embodiment of the systems of the present invention, the employer designates individuals who may reserve the hired vehicles for personal use after the authorized group of employees arrives at the place of employment in the car pool and before the authorized group of employees leaves the place of employment in the car pool.

In another embodiment of the systems of the present invention, the designated individuals who may reserve the hired vehicles for personal use after the authorized group of employees arrives at the place of employment in the car pool and before the authorized group of employees leaves the place of employment in the car pool include those employees who arrive at the place of employment in one of the hired vehicles.

In another embodiment of the systems of the present invention, the designated individuals who may reserve the hired vehicles for personal use after the authorized group of employees arrives at the place of employment in the car pool and before the authorized group of employees leaves the place of employment in the car pool include those employees who arrive at the place of employment without the use of a private vehicle.

In another embodiment of the systems of the present invention, the specified time periods include Monday through Friday from about 6 a.m. to about 8 p.m. In another embodiment of the systems of the present invention, entities hire the vehicles for a time selected from the group consisting of about 4 hours, about 6 hours, about 8 hours, about 10 hours, about 12 hours and about 14 hours.

In another embodiment of the systems of the present invention, the entity is a store and the store authorizes one or more groups of customers to obtain one or more vehicles from the subset of vehicles in the pool from one or more collection points and to use the hired vehicle to car pool to the store. In another embodiment of the systems of the present invention, the entity is a charitable organization and the charitable organization authorizes one or more groups of volunteers to obtain one or more vehicles from the subset of vehicles in the pool from one or more collection points and to use the hired vehicle to car pool to a volunteer location. In another embodiment of the systems of the present invention, the entity is a school and the school authorizes one or more groups of students to obtain one or more vehicles from the subset of vehicles in the pool from one or more collection points and to use the hired vehicle to car pool to the school.

In another embodiment of the systems of the present invention, the designated individuals reserve use of the hired vehicles through the hiring entity. In another embodiment of the systems of the present invention, the designated individuals reserve use of the hired vehicles through a central reservation system that oversees use of all vehicles in the pool of vehicles.

In another embodiment of the systems of the present invention, use of the system by a subscriber requires payment of a fee. In another embodiment of the systems of the present invention, the fee is paid by the hiring entity. In another embodiment of the systems of the present invention, the fee is paid by the authorized individuals. In another embodiment of the systems of the present invention, the fee is paid by the designated individuals. In another embodiment of the systems of the present invention, the fee is paid by the hiring entity, the authorized individuals and the designated individuals. In another embodiment of the systems of the present invention, the fee is subsidized by an individual or entity that is not the hiring entity, an authorized individual or a designated individual.

In another embodiment of the systems of the present invention, the hiring of the vehicle further includes one or more of the group selected from gasoline, parking, insurance, maintenance, cleaning, use scheduling, tracking of use, and emergency assistance.

In another embodiment of the systems of the present invention, the subset of vehicles in the pool designated to be hired by an entity rather than an individual during specified time periods comprises at least one van.

In another embodiment of the systems of the present invention, outside of the specified time periods, the subset of vehicles designated to be hired by an entity during the specified time periods, can be hired by individuals.

The present invention also includes methods of providing a hire vehicle system. In one embodiment of the methods of the present invention, the method comprises providing a pool of vehicles available for hire; providing at least one collection point at which the vehicles are issued; providing a central reservation system; providing a system to verify user identify and reservation status, wherein the system receives identifying information from a potential user, communicates the identifying information to the central reservation system which prompts the system to allow access to a reserved vehicle from the pool of vehicles available for hire in response to positive verification of the user and reservation status wherein a subset of the vehicles in the pool are designated to be hired by entities rather than individuals during specified time periods.

In another embodiment of the methods of the present invention, the collection point is a collection and return point from which the hired vehicles are issued and returned.

In another embodiment of the methods of the present invention, the entity is an employer and the employer authorizes one or more groups of employees to obtain one or more vehicles from the subset of vehicles in the pool from one or more collection points and to use the hired vehicles to car pool to the place of employment.

In another embodiment of the methods of the present invention, the employer uses the hired vehicles as members of its fleet of vehicles after the authorized group of employees arrives at the place of employment in the car pool and before the authorized group of employees leaves the place of employment in the car pool.

In another embodiment of the methods of the present invention, when the employees leave the place of employment in the car pool, the employees return to the collection point which is a collection and return point.

In another embodiment of the methods of the present invention, the employer designates individuals who may reserve the hired vehicles for personal use after the authorized group of employees arrives at the place of employment in the car pool and before the authorized group of employees leaves the place of employment in the car pool.

In another embodiment of the methods of the present invention, the designated individuals who may reserve the hired vehicles for personal use after the authorized group of employees arrives at the place of employment in the car pool and before the authorized group of employees leaves the place of employment in the car pool include those employees who arrive at the place of employment in one of the hired vehicles.

In another embodiment of the methods of the present invention, the designated individuals who may reserve the hired vehicles for personal use after the authorized group of employees arrives at the place of employment in the car pool and before the authorized group of employees leaves the place of employment in the car pool include those employees who arrive at the place of employment without the use of a private vehicle.

In another embodiment of the methods of the present invention, the specified time periods include Monday through Friday from about 6 a.m. to about 8 p.m. In another embodiment of the methods of the present invention, entities hire vehicles for a time selected from the group consisting of about 4 hours, about 6 hours, about 8 hours, about 10 hours, about 12 hours and about 14 hours.

In another embodiment of the methods of the present invention, the entity is a store and the store authorizes one or more groups of customers to obtain one or more vehicles from the subset of vehicles in the pool from one or more collection points and to use the hired vehicle to car pool to the store. In another embodiment of the methods of the present invention, the entity is a charitable organization and the charitable organization authorizes one or more groups of volunteers to obtain one or more vehicles from the subset of vehicles in the pool from one or more collection points and to use the hired vehicle to car pool to a volunteer location. In another embodiment of the methods of the present invention, the entity is a school and the school authorizes one or more groups of students to obtain one or more vehicles from the subset of vehicles in the pool from one or more collection points and to use the hired vehicle to car pool to the school.

In another embodiment of the methods of the present invention, designated individuals reserve use of the hired vehicles through the hiring entity. In another embodiment of the methods of the present invention, designated individuals reserve use of the hired vehicles through a central reservation system that oversees use of all vehicles in the pool of vehicles.

In another embodiment of the methods of the present invention, use of the hire vehicle system by a subscriber requires payment of a fee. In another embodiment of the methods of the present invention, the fee is paid by the hiring entity. In another embodiment of the methods of the present invention, the fee is paid by the authorized individuals. In another embodiment of the methods of the present invention, the fee is paid by the designated individuals. In another embodiment of the methods of the present invention, the fee is paid by the hiring entity, the authorized individuals and the designated individuals. In another embodiment of the methods of the present invention, the fee is subsidized by an individual or entity that is not the hiring entity, an authorized individual or a designated individual.

In another embodiment of the methods of the present invention, the hiring of a vehicle further includes one or more of the group selected from gasoline, parking, insurance, maintenance, cleaning, use scheduling, tracking of use, and emergency assistance.

In another embodiment of the methods of the present invention, the subset of vehicles in the pool designated to be hired by an entity rather than an individual during specified time periods comprises at least one van.

In another embodiment of the methods of the present invention, outside of the specified time periods, the subset of vehicles designated to be hired by an entity during the specified time periods, can be hired by individuals.

### BRIEF DESCRIPTION OF THE FIGURES

FIG. 1 depicts one embodiment of the present invention.

FIG. 2 depicts another embodiment of the present invention.

FIG. 3 depicts yet another embodiment of the present invention.

FIGS. 4A-4D depicts various vehicle availability options that may be presented to different subscribers depending on an individual subscriber's status.

### DETAILED DESCRIPTION OF THE INVENTION

As used herein, the term “entity” refers to a group of people (two or more) that come together for a common purpose. Thus, in its most basic sense, entity can refer to two people with a common purpose. An entity also can include a business, a partnership, a corporation, a team, a school, a club, an organization, a store, etc. Entity also can refer to two or more partnerships, corporations, teams, schools, clubs, organizations, or stores, etc. in any combination that come together for a common purpose.

As used herein, the term “vehicle” means any mode of transportation that can be operated on city or county roads and can accommodate at least two people. Exemplary vehicles include, without limitation, motorcycles, cars, sport-utility vehicles, minivans, vans, trucks and buses, as well as energy-efficient versions of these, including hybrid and electric vehicles and those vehicles with high gas mileage, e.g., 30 m.p.g. or more.

As used herein, the term “car pool” means two or more individuals traveling together in a vehicle. A common destination is not required. “Car pool” and “van pool” can be used interchangeably.

With the present invention, a pool of vehicles is provided at one or more locations (collection points or collection and return points) for shared use among subscribers. Subscribers may reserve the vehicles for their individual use. Subscribers may include individual subscribers and also may include entities. A subset of the provided vehicles is designated for reservation by individuals. Another subset of vehicles is designated for reservation by entities within specified time periods. In one embodiment, the specified time periods include Monday through Friday, about 6 a.m. to about 8 p.m. In another embodiment, the specified time periods include every day of the week from about 12 p.m. to about 12 a.m. In another embodiment of the present invention, the specified time periods include Tuesday through Saturday, about 9 a.m. to about 4 p.m. As these embodiments demonstrate, the present invention is not limited to particular time periods, and any number of vehicles may be placed into a subset designated for use by entities during any give time period. Further, the number of vehicles placed into a subset during a specified time period may change as needed to meet subscriber demand. Outside of the applicable specified time periods, this subset of vehicles is available for reservation by individual subscribers.

When an entity hires a vehicle reserved for entity use during a specified period, the entity may authorize and/or designate individuals who may use the vehicle during the hired period. Authorized individuals are designated to use the vehicle by participating in a car pool that brings the authorized individuals to destinations identified by the hiring entity (“authorized car pool individuals”). In one embodiment, the destination is a common destination for all authorized car pool individuals. In another embodiment, the entity may identify different destinations for different authorized car pool individuals. Other individuals can be designated for use of the vehicle for individual or group trips to subsequent locations after vehicle arrival at the last car pool destination (in some instances, the common destination). These individuals are referred to as designated individuals. Designated individuals may be further subdivided into designated personal individuals and/or designated entity-related individuals. Designated personal individuals are authorized by the entity to use the vehicle for personal reasons. Designated entity-related individuals are authorized to use the vehicle for entity-related reasons. Designated personal/entity-related individuals are authorized to use the vehicle for both personal and entity-related reasons. The entity may designate individuals as belonging to the authorized car pool group, the designated personal use group, the designated entity-related group, all groups or none of the groups.

As previously stated, depending on the choice of the entity, subsequent locations traveled to after arrival at the common destination may include personal destinations of the designated personal individuals (such as, for example and without limitation, the dentists' office, doctors' office, day care, shopping, etc.) or may include entity-related destinations (such as, for example and without limitation, travel to meetings, supplier warehouses, shuttling of individuals between buildings or sites, etc.). The entity may also allow use of the hired vehicles for personal and entity-related destinations. For example, in one embodiment, the entity may reserve the hired vehicle for entity-related destinations and give these destinations priority over personal destinations. If the vehicle is not reserved for travel to an entity-related destination within a give time period, the vehicle may be available for travel to a personal destination. In another embodiment, an entity may hire numerous vehicles from the fleet of available vehicles. In this embodiment, the entity could designate some vehicles for exclusively entity-related destinations and other vehicles for personal destinations.

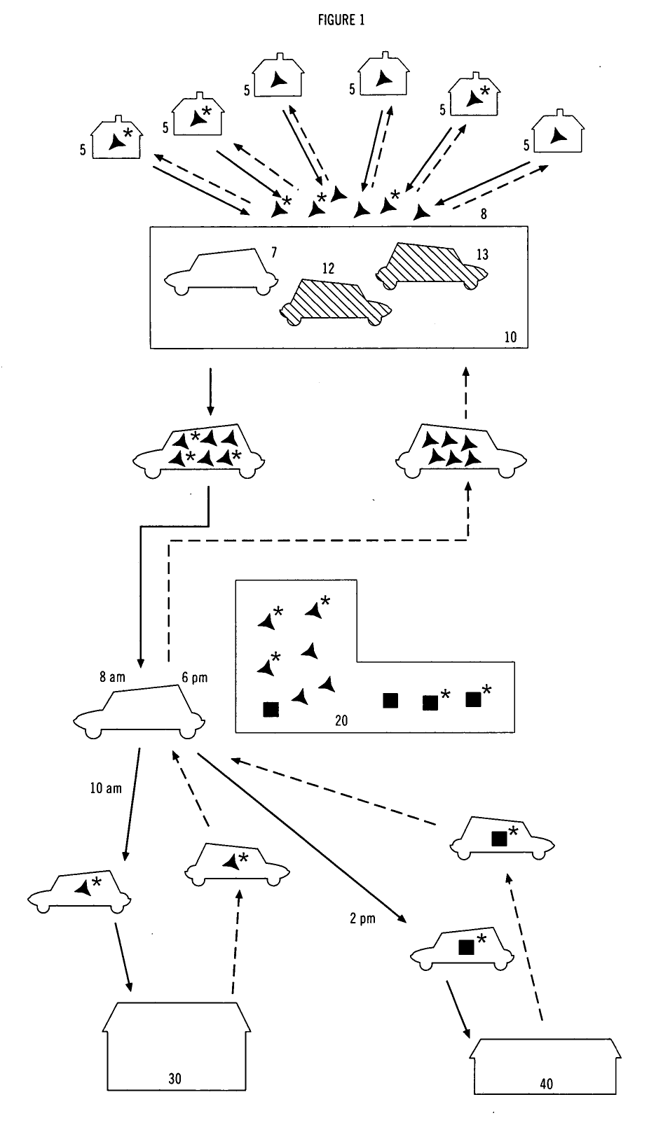

Referring to the FIGS., FIG. 1 depicts one embodiment of the present invention. In this embodiment, a collection and return point 10 houses three vehicles, one designated for reservation and use by entities during specified time periods 7 and two available for reservation and use by individual subscribers at all times 12 and 13. In FIG. 1, an entity has reserved a vehicle 7 during one of the specified times during which a certain subset of vehicles are designated for entity use. The entity also has designated six individuals (represented by triangles) as authorized car pool individuals 8. In this depicted embodiment, these authorized car pool individuals 8 begin at individual starting locations 5 and meet at a collection and return point 10. The authorized car pool individuals 8 pick up a vehicle designated for entity use 7 and travel to a common destination 20 identified by the hiring entity. Once the authorized car pool individuals 8 arrive at the common destination 20, the vehicle 7 is available for use by designated personal use and/or designated entity-related use individuals (marked with an asterisk (*) in FIG. 1). In the embodiment depicted in FIG. 1, the entity has designated five individuals to be designated individuals (personal or entity-related). Three of the designated personal or entity-related individuals are also authorized car pool individuals 8. Two of the designated personal or entity-related use individuals are not authorized car pool individuals 8 (non car pool individuals at the common destination are represented by squares in FIG. 1). In this depicted embodiment, designated individuals use the hired vehicle 7 to travel to two subsequent locations 30 and 40 before the hired vehicle 7 is returned to the collection and return point 10 by the authorized car pool group 8. Again, these subsequent destinations 30 and 40 can be personal destinations or entity-related destinations depending on use guidelines created by the vehicle-hiring entity. Within a time period specified by the hiring entity (for example and without limitation between about 5:30 p.m. and about 6:00 p.m.), the authorized car pool individuals 8 return the vehicle to the collection and return point 10 and then return to their respective individual starting locations 5.

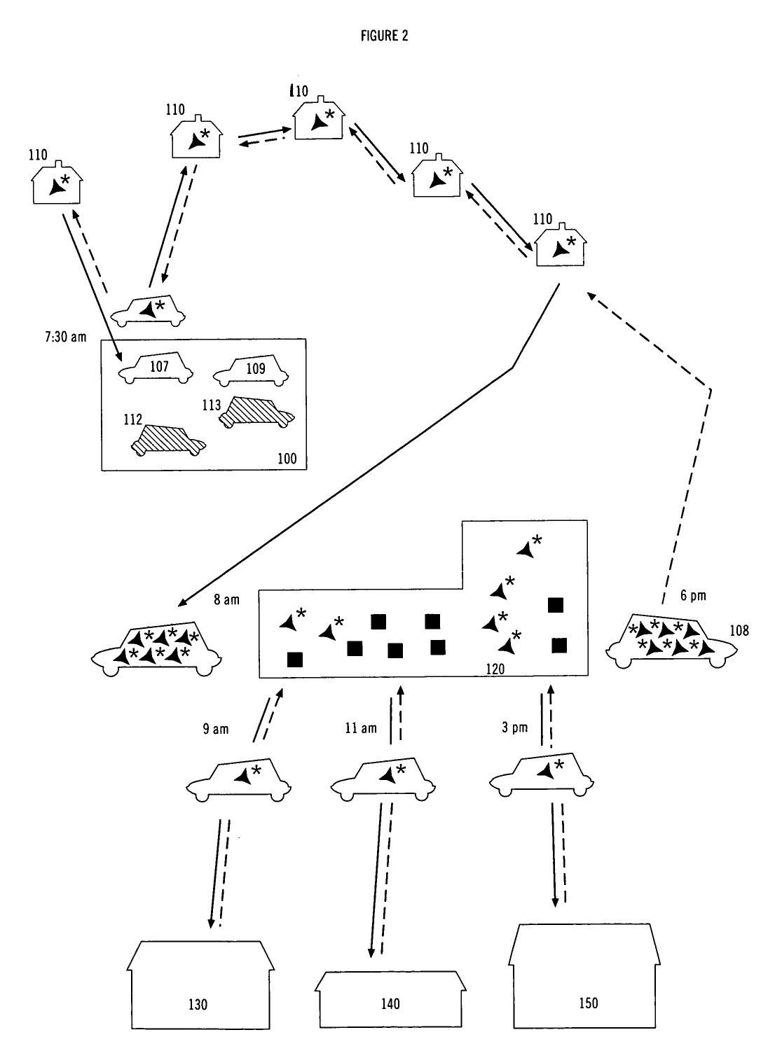

FIG. 2 depicts an alternative embodiment of the present invention. In this embodiment, the entity has designated six individuals (represented by triangles) as authorized car pool individuals 108. In this depicted embodiment, there are two vehicles reserved for entity use 107 and 109 during the specified time periods and two vehicles 112 and 113 that are available for reservation and use by individual subscribers at all times. In this depicted embodiment, one authorized car pool individual picks up the hired vehicle 107 at a collection and return point 100. This individual then picks up the other authorized car pool individuals 108 serially at their respective individual starting locations 110. Once the authorized car pool individuals 108 arrive at the common destination 120, the vehicle 107 is available for use by designated individuals (marked with an asterisk (*) in FIG. 2). In this embodiment, the hiring entity has designated all authorized car pool individuals 108 as designated personal use and designated entity-related use individuals. Further, no other individuals are designated individuals for any use. In the example embodiment depicted in FIG. 2, the hired vehicle 107 is used to reach three subsequent locations, 130, 140 and 150 throughout the course of the day. At the end of the day, the authorized car pool individuals 108 return to their respective-starting locations 110. Again, in this embodiment, one authorized car pool individual drops off each other authorized car pool individual 108 at their respective starting locations 110 serially, returns the hired vehicle to the collection and return point 100 and then returns to that individual's starting location 110.

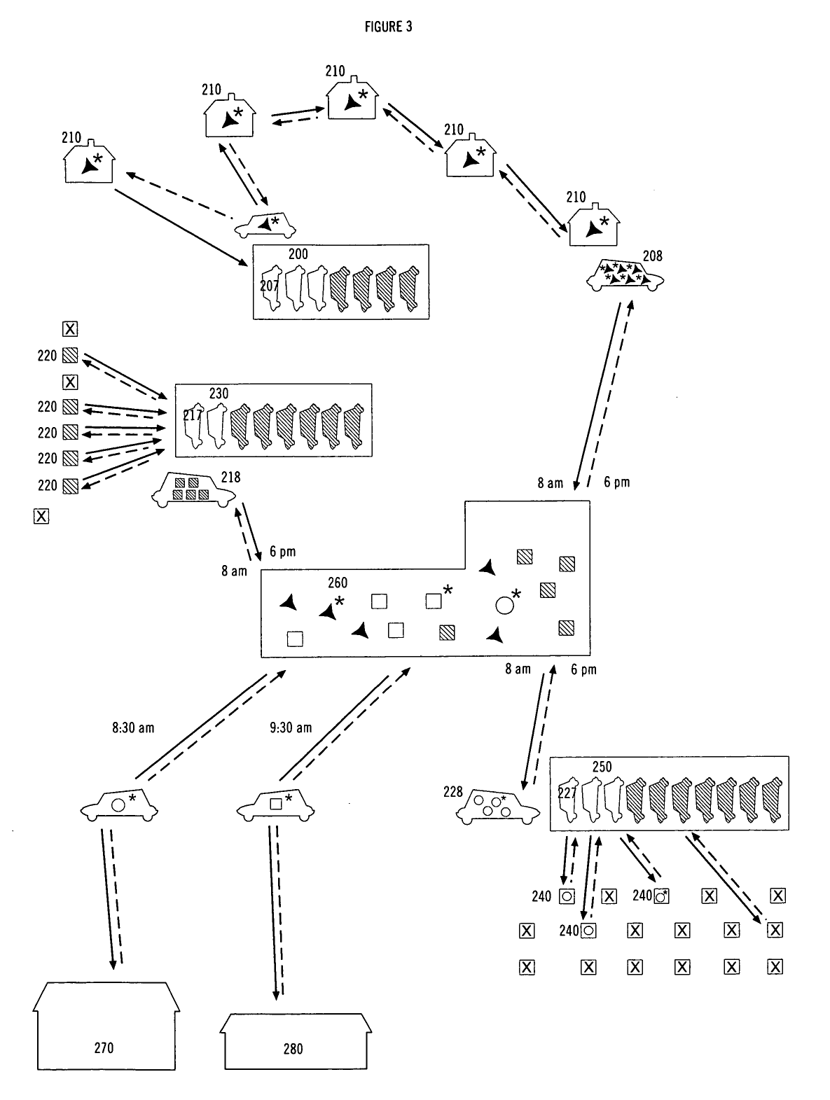

FIG. 3 depicts an alternative embodiment of the present invention. In this embodiment, an entity has hired at least one vehicle 207, 217 and 227 from three different collection and return points, 200, 230 and 250 that house vehicles reserved for entity use during specified time periods (blank outline vehicles) as well as vehicles reserved for individual subscriber use at all times (hatched vehicles). In the embodiment depicted in FIG. 3, three different groups of authorized car pool individuals (represented by triangles 208; hatched boxes 218; and circles 228) use vehicles 207, 217 and 227 from the three different collection and return points, 200, 230 and 250 respectively. In Group 1, one authorized car pool individual 208 retrieves the hired vehicle 207 from a collection and return point 200. This authorized car pool individual 208 then picks up each other authorized car pool individual 208 in Group 1 serially from each individuals respective starting location 210. Once the last Group 1 authorized car pool individual 208 is picked up, Group 1 travels to the common destination 260. The authorized car pool individuals in Groups 2 (218) and 3 (228) leave their individual starting locations 220 and 240 to meet at their respective collection and return points 230 and 250, retrieve hired vehicles 217 and 227, and travel to the common destination 260. Once hired vehicles 207, 217 and 227 arrive at the common destination 260, the vehicles 207, 217 and 227 become available for use by designated individuals (marked with an asterisk (*)) in accordance with restrictions placed upon vehicle use by the hiring entity. In FIG. 3, two trips to subsequent locations 270 and 280 are made before the authorized car pool individuals 208, 218 and 228 return the hired vehicles 207, 217 and 227 to collection and return points 200, 230 and 250. When the hired vehicles 207, 217 and 227 are returned to the collection and return points 200, 230 and 250 and the specified time period ends, these vehicles become available for use by individual subscribers (marked as Xs in FIG. 3) until a new time period of designated entity use begins (generally, but not always) the following morning.

In FIGS. 1-3, the designated car pool individuals return the hired vehicle to a collection and return point. One should note that while this pattern is common in the methods and systems of the present invention, it is not required. For instance, as later described, many vehicles available for use with the present invention are equipped with GPS systems that apprise the central reservation system of the vehicle's present location. In these embodiments, a vehicle retrieved from a particular collection and return point may be returned to an area rather than a specific collection and return point, for example and without limitation, an area within a six block radius of the collection and return point. A subsequent user, then, instead of retrieving the car from the collection and return point can be notified to retrieve the car from its particular location within the six block radius. Alternatively, at certain times, the vehicles available for hire must be serviced. If a subscriber uses the vehicle before the next scheduled service, this user could be allowed to leave the vehicle anywhere within city limits where it could be retrieved by those managing the pool of vehicles for service. Thus, while the vehicles of the present invention generally are returned to the collection and return point where they were retrieved, this model is not required in all instances.

In one embodiment of the systems of the present invention, the system includes a pool of vehicles available for hire, at least one collection and return point at which the vehicles are issued and taken back; a central reservation system; and a system to verify user identify and reservation status, wherein the system receives identifying information from a potential user, communicates the identifying information to the central reservation system which, in return, prompts the system to allow access to a reserved vehicle from the pool of vehicles available for hire in response to a positive verification of the user identity and his reservation status. In this embodiment, a subset of vehicles in the pool are designated to be hired by an entity rather than an individual during specified time periods.

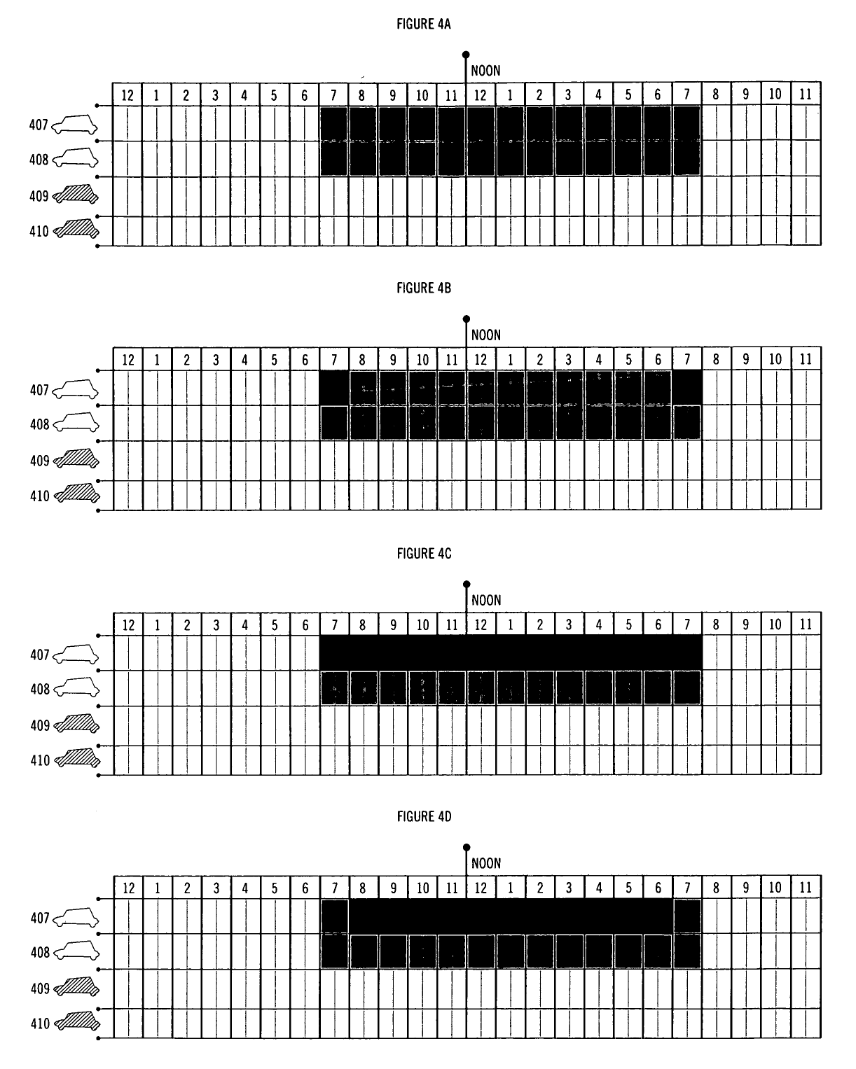

In one embodiment, in use, a subscriber (potential user) contacts the central reservation system by, for example and without limitation, a phone or through the internet. The central reservation system allows the subscriber to identify vehicle availability at various collection and return points. If the subscriber checks vehicle availability at a collection and return point that houses both regular vehicles and vehicles that are reserved for use by entities, the subscriber may see different availabilities depending on the status of the subscriber and his particular authorizations. For example, in one embodiment, each subscriber is given an identifying member number and PIN number. These identifying numbers can provide the central reservation system with information such as whether the subscriber is associated with an entity that is also a subscriber, is an individual authorized for car pool use by a hiring entity, is an individual designated for personal or entity related use by a hiring entity, or is not associated with any entity subscribers. FIG. 4 depicts what different individual subscribers may see if these individuals checked the availability of vehicles at a certain collection and return point. The depicted schedule shows vehicle availability for a collection and return point that has two vehicles that are reserved for entity use during the hours of 7 a.m. and 7 p.m. (407 and 408) and two vehicles that are available for reservation and use by individual subscribers at all times (409 and 410). In FIG. 4A, the subscriber checking availability is not associated with an entity that has reserved a vehicle from the particular collection and return point. Thus, all vehicles reserved for use by entities during the specified times appear as reserved to this individual during the specified times (grey fill). Thus, the individual only has the option of reserving this subset of vehicles during the non-specified times (8 p.m. to 7 a.m.). The individual is free, however, to reserve and use vehicles 409 and 410 which are not reserved for entity use at any time. In FIG. 4B, the individual is an authorized car pool individual of an entity that has hired vehicle 407 for the duration of the specified time period, in this example 7 a.m. to 8 p.m. This individual sees vehicle 408, the vehicle reserved for entity hire but not hired by his associated entity as reserved. Because this individual is only an authorized car pool individual, vehicle 407, the vehicle his associated entity has reserved, shows availability (black fill) during time slots the entity has designated for car pool use (in this example, 7 a.m. to 8 a.m. and 7 p.m. to 8 p.m.). This individual may subreserve the vehicle during these time periods and coordinate with his like group members to car pool to the entity's designated common destination. This individual is also free to reserve and use vehicles 409 and 410 which are available for individual subscriber use at all times. In FIG. 4C, the individual checking availability is associated with the entity that has reserved car 407 and is an authorized car pool individual as well as a designated personal and designated entity-related user. Vehicle 408, not reserved by this individual's associated entity appears as reserved to the user whether or not the vehicle has actually been reserved. Vehicle 407 appears as available to the user throughout the course of the day. The vehicle is available to this individual as an individual subscriber from 8 p.m. to 7 a.m., is available to this individual as an authorized car pool individual of the hiring entity from 7 a.m. to 8 a.m. and 7 p.m. to 8 p.m. and is available to this individual as a designated personal and designated entity-related individual from 8 a.m. to 7 p.m. This individual could also reserve vehicles 409 and 410 at any time. In FIG. 4D, the individual checking availability of the vehicles at the depicted collection and return point is a designated personal and designated entity-related individual associated with the entity that has reserved vehicle 407. Thus, vehicle 408 appears as reserved to this individual regardless of whether it is actually reserved by another non-associated entity. Vehicle 407 appears as available to this user outside of the specified times (8 p.m. to 7 a.m.) and during the times reserved by his associated entity that are not otherwise set aside for car pool use (8 a.m. to 7 p.m.). The preceding description of FIG. 4 assumes that an entity has reserved a vehicle for the entirety of a specified time period and has left more discrete allotment of reservation times to the central reservation system. In another embodiment, however, an entity may reserve a vehicle for a period of time and choose to handle reservations of more discrete time allotments on its own. In this case, once the entity has reserved the vehicle, it will be marked as unavailable to all other subscribers regardless of whether these subscribers are associated with the entity as authorized or designated individuals or not.

When a subscriber checks vehicle availability in advance as just described, the subscriber can reserve a desired vehicle in advance if one is available. For example, the subscriber may contact the central reservation system, provide his name and/or member and pin number, the desired starting collection and return point, the expected time of vehicle use, and the destination collection and return point. In response to this information, the central reservation system can check the subscriber authorization and the availability of possible vehicles for the desired journey. The subscriber can then select a desired vehicle if he wishes, being informed by the central reservation system about the current and future planned availability of vehicles and free parking places at the individual collection and return points. If the subscriber finds the information presented by the central reservation system acceptable, the subscriber may confirm a reservation. Once a reservation is confirmed, the time of the reservation will appear as unavailable to other potential users. This marking on the schedule will remain until the reserving subscriber changes or cancels his reservation.

Once a reservation by an entity has been made, an individual must retrieve the hired vehicle from the appropriate collection or collection and return point. Thus, the entity must authorize at least one individual to retrieve the hired vehicle from the appropriate collection and return point. While collection and return points are described from here on, one should recall that in certain embodiments of the present invention, these points could be collection points with return occurring at a different location. Generally, the individual or individuals retrieving a car on behalf of an entity will be authorized car pool individuals, however, the entity may authorize other individuals to retrieve and/or return the hired vehicle as it deems appropriate for its particular uses. When an individual is authorized to retrieve and/or return a vehicle on behalf of an entity, this information can be attached to the individual's member number and pin number. The authorizations made by the hiring entity can be indefinite (i.e. any time the entity has hired a vehicle, a particular individual is authorized to retrieve and/or return the vehicle) or can be circumscribed to more particular times (i.e., a particular individual may be authorized to retrieve and/or return a hired vehicle on a particular day or according to a particular schedule). Authorizations of individuals associated with an entity can be tracked and managed by the central reservation system.

When an authorized individual arrives to retrieve and/or return a hired vehicle, the authorized individual can gain access to the hired vehicle in a number of ways. For example, in one embodiment, each vehicle available for hire includes an in-vehicle computer and a card reader that communicates with the in-vehicle computer. The card reader may be in the vicinity of its associated vehicle (when the vehicle is parked in an assigned parking space) or may be within the vehicle itself. Each subscriber of the service is issued a personalized identification card. Access to a reserved vehicle can be achieved by placing the individual's personalized identification card near a particular vehicle's card reader. If the vehicle's card reader identifies the individual's personalized identification card as matching that of an individual that is authorized to retrieve the vehicle during the applicable reservation time (through communication with the in-vehicle computer), the card reader allows an access module to unlock the vehicle's doors. While the card reader may obtain such reservation information from the central reservation system through the computer found within its particular vehicle which may in turn communicate with the central reservation system, this card reader also may communicate with the central reservation system directly.

Once an authorized individual has gained access to a vehicle and retrieved the vehicle's keys (for instance and without limitation, from the glove box), the ignition is still disabled. In this embodiment, to enable ignition of the vehicle, the authorized individual must provide his personalized pin number to the particular vehicle's computer (for instance, and without limitation, a computer mounted into the dashboard of the vehicle). This computer communicates the individual's pin number to the central reservation system which again verifies reservation time and authorization to retrieve the vehicle. If verification occurs, the central reservation system allows the in-vehicle computer to enable the ignition. At this time, the authorized individual is able to remove the hired vehicle from the collection and return point on behalf of the hiring entity. The card reader or the computer in the vehicle can record and report the time when a vehicle is accessed and/or the ignition enabled and transmit this information to the central reservation system.

In another embodiment of the present invention, the system allows access to vehicles through a collection and return machine found at each collection and return point. In this embodiment, an individual can make a reservation either via an information transmission channel which is independent of the collection and return point (such as through, for example and without limitation a telephone or the internet as described earlier) or directly through the collection and return machine at a collection and return point. For example, a subscriber may, through, for example and without limitation, dialogue interfaces at an automatic collection and return point machine, make and confirm a reservation for use of a vehicle which is presently available or will be available at the particular collection and return point.

Once reservation requests are made according to any of the methods, the central reservation system can inform the subscriber about availability of vehicles at specific collection and return points. In response to a confirming reservation request, the central reservation center can couple the issuing of a driving authorization for the reserved vehicle to the inputting of subscriber identity information related to the person or entity making the reservation. Thus, it is ensured that the subscriber actually finds the reserved vehicle at the desired collection and return point at the desired time, and can activate it. Again, if the subscriber confirming a reservation request is an entity, the entity may provide identifying information for itself and for an individual that is authorized to retrieve the vehicle in the entity's behalf. Thus, regardless of how an entity chooses to use the hired vehicle during the hired time, it must give at least one individual authority to remove the hired vehicle from a collection and return point.

In order for an individual authorized by an entity to remove a vehicle from a collection and return point, the authorized individual must again prove his identity at the collection and return point. As described earlier, in one embodiment, identity of an individual can be adequately verified with the use of a subscriber-specific identification card and pin number. In another embodiment, instead of using a card reader found within the hired vehicle or in its immediate vicinity, an individual can establish a communication link with an automatic collection and return machine through the use of an identification card which identifies him as an individual authorized for vehicle pickup by the hiring entity.

When successful identification of an authorized individual has occurred through a collection and return machine, the machine can issue a driving authorization unit for a vehicle which is ready to be picked up at the collection and return point. In one embodiment, the driving authorization unit may be a vehicle key which can be dispensed from the collection and return machine. In another embodiment of the invention, the driving authorization unit may be a card that is coded for a specific vehicle and can serve as access authorization for the selected vehicle. This card also can be issued by the automatic collection and return machine. For example, in this embodiment, driving-authorizing cards or keys whose associated vehicles are ready to be picked up at each collection and return point are stored in the corresponding automatic collection and return machine, ready to be issued. At a booked hiring time an authorized individual goes to the corresponding starting collection and return point and identifies himself at the automatic collection and return machine by presenting his identification card. By way of, for example, a dedicated line or through radio communication, the automatic collection and return machine can transfer the presented identification data to the central reservation center where it tests for an existing reservation. If the identification is successful, the central reservation system selects a vehicle from the group of associated collection and return points (if appropriate the reserved vehicle), and transmits back a corresponding card issuing or key issuing signal to the automatic collection and return machine. This signal causes the collection and return machine to issue the associated card or key. At the same time, the automatic collection and return machine can report the time when the card or key was issued, the identity of the collection and return point and the identity of the vehicle to the central reservation center.

At this time the authorized individual can take the card or key from the automatic collection and return machine. If a card, a card reader on the associated vehicle will unlock the vehicle in response to presentation of the appropriate card. The card also can disarm an immobilizer (i.e., enable the ignition). Furthermore, so that the battery of the vehicle is not continuously loaded, the card reader can be activated by means of a mechanical microswitch after the chip card has been read. The vehicle can then be activated with the ignition key lying in the vehicle. (It is of course possible as an alternative for the ignition key to be dispensed with, and instead a starter knob to be actuated.). While not necessary, in one embodiment, the authorized individual leaves the starting collection and return point with the hired vehicle by passing an exit barrier actuated by means of induction loops.

In embodiments of the present invention, the hired vehicle also can be locked by means of a card (the individual subscriber's card or the card issued from a card issuing machine) without conventional mechanical locking system being required. Further, a warning buzzer can sound if an attempt is made to lock the vehicle with the card if the ignition has not been switched off correctly.

Optionally, each collection and return point can be equipped with video monitoring with resulting signals from the video camera being transmitted to the central reservation center via a data exchange link between the collection and return point and the central reservation center. Furthermore, each collection and return point can optionally be protected against entry by those who are not subscribers or authorized individuals by an access-controlling turnstile, which is released by inserting an acceptable identification or card.

Once a vehicle is removed from a collection and return point by an authorized individual, the hiring entity may decide to use the vehicle in any number of ways. As described earlier, the entity may provide the vehicle to a group of individuals with a common destination that can use the hired vehicle to car pool to the destination. This use reduces the number of individuals arriving at the common destination in privately-owned or operated vehicles. The entity may also choose to use the hired vehicle to travel to destinations associated with its endeavors.

As described earlier, when a hiring entity allows various users to use one or more hired vehicles, the entity may track and manage use itself during the hired time. The hiring entity also may use the central reservation center to aid in “sub-reservations” occurring during the hired time period. Indeed, the systems and methods of the present invention provide various services in addition to providing a vehicle for use. The systems and methods of the present invention can include any combination of gas, insurance, maintenance, roadside assistance, emergency assistance, cleaning, scheduling, and use tracking.

In one embodiment of the systems and methods of the present invention, the hired vehicles can be equipped with a satellite locating device, comprising a GPS receiver, Modacom terminal and aerial so that location data may be transmitted to the central reservation center by means of the Modacom terminal via a radio link. At the central reservation center, the current positions of the vehicles of the pool of vehicles can then be indicated, for example on a map on a computer screen. In addition, the location data can be used, by means of appropriate evaluation, to determine the route which has been taken during a hire journey. This information can be provided to the hiring entity so that the entity may track use of the hired vehicle by various authorized individuals or sub-groups within the entity. This information also can be used for the purpose of tracking use for billing purposes. As stated earlier, this information is also useful when a return point is not the collection and return point from which a vehicle was retrieved.

In yet another embodiment of the invention the monitoring of the vehicle by the central reservation center is improved in that the current position of the vehicle is determined at the vehicle end by locating means and corresponding position information is then transmitted to the central reservation center by the vehicle. This permits the central reservation center to make an even more reliable prediction of when specific vehicles will be present at specific collection and return points than would be possible solely on the basis of a subscriber stating his destination collection and return point when beginning his journey.

Via the optional mobile communication link between the hired vehicles and the central reservation center, it is possible to inform the central reservation center of faults in the vehicles and/or to transfer vehicle operating data which can be evaluated at the central reservation center in order to determine, for example, servicing intervals. The vehicle/central reservation center communication link can also be bidirectional in order, for example, to disable a vehicle reported as stolen by setting the immobilizer under remote control from the central reservation center after the ignition has been switched off.

As an alternative to collecting vehicle operating data via the vehicle/central reservation center communication link, by correspondingly configuring cards and associated card readers, vehicle operating data may also be stored on the card itself, and read out by a particular vehicle's card reader when the vehicle is locked by the card at the end of a hire or alternatively by the automatic collection and return machine when the card is returned to this machine. This data can then be transmitted from there to the central reservation center via the associated data exchange link. In this manner, information permitting optimum care and servicing of the vehicles in the pool can be obtained.

Furthermore, the maximum hire period may be stored on a vehicle card and transferred to the locking system control unit of the vehicle via the vehicle-side card reader after the card has been issued. The locking system control unit then ensures that the vehicle is deactivated after the ignition is switched off when the maximum period of use has expired. As a further option in each case a vehicle-mounted computer with associated visual display unit (VDU) is provided in each vehicle in the pool in order to provide subscriber guidance and instruction on using the hire vehicle transport system.

Many collection and return points do not include entry barriers. Indeed, vehicles are protected from unauthorized use through the use of personalized member cards and associated card readers within the vehicles. In some embodiments of the present invention, however, collection and return points may include entry barriers. When a hired vehicle arrives at a destination collection and return point that does include an entry barrier, the entry barrier must be initially actuated. In one embodiment, this actuation may occur by inserting a vehicle card or a subscriber's personal identification card into a barrier-side card reader. After the vehicle is parked in a free stand in the collection and return area, the vehicle is locked again, in one embodiment, with the vehicle chip card and in another embodiment with an individual user's personal identification card. In another embodiment, the vehicle can be relocked with the dispensed key. A vehicle card or a dispensed key can be returned via a card pull-in mechanism on an automatic collection and return machine or a key acceptance mechanism of the key-issuing device. Thus, in these embodiments, it is thus ensured that each automatic collection and return machine contains, at any one time, precisely the chip cards or keys of the vehicles located in the associated collection and return area.

When a vehicle is returned, information regarding the vehicle's journey can be transmitted to the central reservation system. For example, in one embodiment, a vehicle's individual card reader can transmit information to the central reservation system. In another embodiment, the automatic collection and return machine can read the identity of the vehicle and transmit this information, together with the identity of the collection and return point and the time of return, to the central reservation center. Alternatively, return of a key can trigger a communication link to a central monitoring and recording station that can record the period for which a vehicle in use has been hired from the departure and arrival times. Each automatic collection and return machine also can be equipped with a printer which can be used, after the termination of a hire journey and return of the vehicle chip card or key, to issue a receipt for the hire charge incurred while the rest of the billing process is carried out via the central reservation center. Likewise, in some embodiments, the computer found within hired vehicles may issue a similar receipt.

In most instances, use of the vehicles in accordance with the present invention requires payment of a fee. This fee can be assessed in a number of different ways. For example, the fee could be a flat fee or a per use fee. If a per use fee, the fee could be calculated according to time the vehicle is reserved or miles traveled. In addition, a user could pay a weekly, monthly or yearly subscription fee. As will be apparent to those of skill in the art, there are numerous ways to structure fee assessment in keeping with the present invention. In one embodiment, no matter what the fee procedure, the hiring entity can pay the entire fee. In another embodiment, the fee can be paid by authorized car pool individuals. In another embodiment, the fee can be paid by designated personal use users. In another embodiment, the fee can be paid by designated entity-related use users. In another embodiment, the fee can be paid by a combination of the hiring entity, authorized car pool individuals, designated personal use individuals and designated entity-related use individuals in any combination or percentage chosen by the hiring entity or agreed to by all those involved. In another embodiment, the fee can be subsidized by an entity or individual not associated with the hiring entity. For instance, in one embodiment, the fee may be subsidized by the federal government. In another embodiment the fee may be subsidized by a state government. In another embodiment the fee may be subsidized by a local government. In another embodiment the fee may be subsidized by a city authority. All of these options are provided by way of example and are not intended to limit the numerous fee or subsidy paradigms available to be used in accordance with the present invention.

It is to be understood that the present invention is not limited to the particular embodiments, materials, and examples described herein, as these can vary. It also is to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a vehicle” or “an entity” is a reference to one or more vehicles or entities and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

What is claimed is:

1. A hire vehicle transportation system comprising:
a pool of vehicles available for hire;
at least one collection point at which the vehicles are issued;
a central reservation system;
a system to verify user identify and reservation status, wherein said system receives identifying information from a potential user and communicates said identifying information to said central reservation system, which prompts said system to allow access to a reserved vehicle from said pool of vehicles available for hire in response to positive verification of said user and reservation status, wherein a subset of said vehicles in said pool are designated to be hired by entities rather than individuals during specified time periods.

2. The hire vehicle transportation system according to claim 1, wherein said collection point is a collection and return point from which said hired vehicles are issued and returned.

3. The hire vehicle transportation system according to claim 1, wherein one said entity is an employer and said entity authorizes one or more groups of employees to obtain one or more vehicles from said subset of said vehicles in said pool from one or more collection points and to use said hired vehicles to car pool to the place of employment.

4. The hire vehicle transportation system according to claim 3, wherein said employer uses said hired vehicles as members of said employer's fleet of vehicles after said authorized group of employees arrives at said place of employment in said car pool and before said authorized group of employees leaves said place of employment in said car pool.

5. The hire vehicle transportation system according to claim 4, wherein when said employees leave said place of employment in said car pool, said employees return to said collection point, which is a collection and return point.

6. The hire vehicle transportation system according to claim 4, wherein said employer designates individuals who may reserve said hired vehicles for personal use after said authorized group of employees arrives at said place of employment in said car pool and before said authorized group of employees leaves said place of employment in said car pool.

7. The hire vehicle transportation system according to claim 6, wherein said designated individuals who may reserve said hired vehicles for personal use after said authorized group of employees arrives at said place of employment in said car pool and before said authorized group of employees leaves said place of employment in said car pool include those employees who arrive at said place of employment in one of said hired vehicles.

8. The hire vehicle transportation system according to claim 6, wherein said designated individuals who may reserve said hired vehicles for personal use after said authorized group of employees arrives at said place of employment in said car pool and before said authorized group of employees leaves said place of employment in said car pool include those employees who arrive at said place of employment without the use of a private vehicle.

9. The hire vehicle transportation system according to claim 1, wherein said specified time periods include Monday through Friday from about 6 a.m. to about 8 p.m.

10. The hire vehicle transportation system according to claim 1, wherein said entities hire said vehicles for a time selected from the group consisting of about 4 hours, about 6 hours, about 8 hours, about 10 hours, about 12 hours and about 14 hours.

11. The hire vehicle transportation system according to claim 1, wherein one said entity is a store and said entity authorizes one or more groups of customers to obtain one or more vehicles from said subset of said vehicles in said pool from one or more collection points and to use said hired vehicle to car pool to said store.

12. The hire vehicle transportation system according to claim 1, wherein one said entity is a charitable organization and said entity authorizes one or more groups of volunteers to obtain one or more vehicles from said subset of said vehicles in said pool from one or more collection points and to use said hired vehicle to car pool to a volunteer location.

13. The hire vehicle transportation system according to claim 1, wherein said entity is a school and said entity authorizes one or more groups of students to obtain one or more vehicles from said subset of said vehicles in said pool from one or more collection points and to use said hired vehicle to car pool to said school.

14. The hire vehicle transportation system according to claim 6, wherein said designated individuals reserve use of said hired vehicles through the hiring entity.

15. The hire vehicle transportation system according to claim 6, wherein said designated individuals reserve use of said hired vehicles through said central reservation system of claim 1.

16. The hire vehicle transportation system according to claim 1, wherein use of said system by a subscriber requires payment of a fee.

17. The hire vehicle transportation system according to claim 16, wherein said fee is paid by said entity.

18. The hire vehicle transportation system according to claim 3, wherein said fee is paid by said authorized individuals.

19. The hire vehicle transportation system according to claim 6, wherein said fee is paid by said designated individuals.

20. The hire vehicle transportation system according to claim 6, wherein said fee is paid by said entity, said authorized individuals and said designated individuals.

21. The hire vehicle transportation system according to claim 16, wherein said fee is subsidized by an individual or entity that is not the hiring entity, an authorized individual or a designated individual.

22. The hire vehicle transportation system according to claim 1, wherein hiring of said vehicle further includes one or more of the group selected from gasoline, parking, insurance, maintenance, cleaning, use scheduling, tracking of use, and emergency assistance.

23. The hire vehicle transportation system according to claim 1, wherein said subset of said vehicles in said pool designated to be hired by an entity rather than an individual during specified time periods comprise at least one van.

24. The hire vehicle transportation system according to claim 1, wherein outside of said specified time periods, said subset of vehicles designated to be hired by an entity during said specified time periods, can be hired by individuals.

25. A method of providing a hire vehicle transportation system comprising:
providing a pool of vehicles available for hire;
providing at least one collection point at which the vehicles are issued;
providing a central reservation system;
providing a system to verify user identify and reservation status, wherein said system receives identifying information from a potential user, communicates said identifying information to said central reservation system which prompts said system to allow access to a reserved vehicle from said pool of vehicles available for hire in response to positive verification of said user and reservation status wherein a subset of said vehicles in said pool are designated to be hired by entities rather than individuals during specified time periods.

26. The method according to claim 25, wherein said provided collection point is a collection and return point from which said hired vehicles are issued and returned.

27. The method according to claim 25, wherein one said entity is an employer and said entity authorizes one or more groups of employees to obtain one or more vehicles from said subset of said vehicles in said pool from one or more collection points and to use said hired vehicles to car pool to the place of employment.

28. The method according to claim 27, wherein said employer uses said hired vehicles as members of said employer's fleet of vehicles after said authorized group of employees arrives at said place of employment in said car pool and before said authorized group of employees leaves said place of employment in said car pool.

29. The method according to claim 28, wherein when said employees leave said place of employment in said car pool, said employees return to said collection point which is a collection and return point.

30. The method according to claim 28, wherein said employer designates individuals who may reserve said hired vehicles for personal use after said authorized group of employees arrives at said place of employment in said car pool and before said authorized group of employees leaves said place of employment in said car pool.

31. The method according to claim 30, wherein said designated individuals who may reserve said hired vehicles for personal use after said authorized group of employees arrives at said place of employment in said car pool and before said authorized group of employees leaves said place of employment in said car pool include those employees who arrive at said place of employment in one of said hired vehicles.

32. The method according to claim 30, wherein said designated individuals who may reserve said hired vehicles for personal use after said authorized group of employees arrives at said place of employment in said car pool and before said authorized group of employees leaves said place of employment in said car pool include those employees who arrive at said place of employment without the use of a private vehicle.

33. The method according to claim 25, wherein said specified time periods include Monday through Friday from about 6 a.m. to about 8 p.m.

34. The method according to claim 25, wherein said entities hire said vehicles for a time selected from the group consisting of about 4 hours, about 6 hours, about 8 hours, about 10 hours, about 12 hours and about 14 hours.

35. The method according to claim 25, wherein one said entity is a store and said entity authorizes one or more groups of customers to obtain one or more vehicles from said subset of said vehicles in said pool from one or more collection points and to use said hired vehicle to car pool to said store.

36. The method according to claim 25, wherein one said entity is a charitable organization and said entity authorizes one or more groups of volunteers to obtain one or more vehicles from said subset of said vehicles in said pool from one or more collection points and to use said hired vehicle to car pool to a volunteer location.

37. The method according to claim 25, wherein said entity is a school and said entity authorizes one or more groups of students to obtain one or more vehicles from said subset of said vehicles in said pool from one or more collection points and to use said hired vehicle to car pool to said school.

38. The method according to claim 30, wherein said designated individuals reserve use of said hired vehicles through the hiring entity.

39. The method according to claim 30, wherein said designated individuals reserve use of said hired vehicles through said central reservation system of claim 1.

40. The method according to claim 25, wherein use of said system by a subscriber requires payment of a fee.

41. The method according to claim 40, wherein said fee is paid by said entity.

42. The method according to claim 27, wherein said fee is paid by said authorized individuals.

43. The method according to claim 30, wherein said fee is paid by said designated individuals.

44. The method according to claim 30, wherein said fee is paid by said entity, said authorized individuals and said designated individuals.

45. The method according to claim 40, wherein said fee is subsidized by an individual or entity that is not the hiring entity, an authorized individual or a designated individual.

46. The method according to claim 25, wherein hiring of said vehicle further includes one or more of the group selected from gasoline, parking, insurance, maintenance, cleaning, use scheduling, tracking of use, and emergency assistance.

47. The method according to claim 25, wherein said subset of said vehicles in said pool designated to be hired by an entity rather than an individual during specified time periods comprise at least one van.

48. The method according to claim 25, wherein outside of said specified time periods, said subset of vehicles designated to be hired by an entity during said specified time periods, can be hired by individuals.
